(19) United States
(12) Patent Application Publication
(10) Pub. No.: US 2006/0030356 A1
(43) Pub. Date: Feb. 9, 2006

(54) Communication device and method of operation therefore

(76) Inventors: Dave Ryan Haub, San Diego, CA (US); William P. Alberth JR., Crystal Lake, IL (US); Timothy P. Froehling, Palatine, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/912,459

(22) Filed: Aug. 5, 2004

(51) Int. Cl. H04M 1/00

(52) U.S. Cl. 455/553.1; 455/552.1

(57) ABSTRACT

A communication device (100) includes a first communication means (140) for operating in a first operating mode; a second communication means (110, 130) for operating in a second operating mode; and an operation control manager (150) coupled between the first communication means (140) and the second communication means (110, 130). The operation control manager (150) is adapted to detect a performance impact in the second communication means (110, 130); and modify the first communication means (140) to reduce the performance impact.

### BACKGROUND OF THE INVENTION

1. Field of the Invention

The present invention is generally related to communication devices and in particular to communication devices capable of operating in multiple modes simultaneously.

2. Description of the Related Art

Cellular telephones, PDAs (Personal Digital Assistants) and other portable electronic devices having communication capability have become fixtures of everyday life over the last several years. As they evolve, device prices and size continue to fall while the devices' capabilities have expanded. Currently, such devices can be used in many places to initiate telephone calls, make wireless connection to the Internet, play games, as well as carry out electronic mail (email) and other messaging functions. It can readily be anticipated that as time goes by, the capabilities of such devices will continue to expand as prices continue to fall, making use of such devices a permanent part of people's daily lives.

Many communication devices today, for example, incorporate the capability of multiple operating modes. For example, a communication device can simultaneously operate on a wideband communication network for radio frequency communication, on a location network for location tracking, and on a short wave network for local area network communication. One drawback of the simultaneous operation is the potential for interference between the multiple operating modes which then can lead to a degradation in overall device performance.

Reduced device size also can create challenges to overall performance. For example, the smaller size provides a need for smaller communication modules. This reduces the performance of the filters used to reduce transmitter noise and interference. Smaller sized device also reduces the available isolation between the various communication antennas. The end result is that some loss in performance in the alternate operation modes can be experienced due to operation in one mode. For example, degradation in radio frequency communication performance and/or location tracking performance may be experienced when operating in a local area network communication mode.

One operation mode which is gaining popularity in communication devices is Bluetooth. Bluetooth is a standard that allows electronic equipment, from computers and cellular telephones to keyboards and headphones, to make its own connections, without wires, cables or any direct action from a user. One method of reducing Bluetooth interference with respect to other operating modes within the communication device is to do frequency hopping as described in the Bluetooth standard. Unfortunately, frequency hopping does not reduce the noise in bands at large offsets from the ISM band (Bluetooth is specified to operate in the Industrial-Scientific-Medical (ISM) band), for example for operation within GPS (Global Positioning System) and wideband radio frequency communication. At large offsets, the noise spectrum due to the Bluetooth transmitter is essentially flat and thus a change in frequency within the ISM band is of no effect.

### BRIEF DESCRIPTION OF THE DRAWINGS

The accompanying figures, where like reference numerals refer to identical or functionally similar elements throughout the separate views and which together with the detailed description below, are incorporated in and form part of the specification, serve to further illustrate various embodiments and to explain various principles and advantages all in accordance with the present invention.

FIG. 1 is an electronic block diagram illustrating a communication device.

FIG. 2 is a flowchart illustrating one embodiment of the operation of the communication device of FIG. 1.

### DETAILED DESCRIPTION

The present invention relates to a communication device and method of operation therefore which provides for modifying the performance of the Bluetooth system to minimize the negative impact on the other modes of the communication device. The algorithm associated with this method of operation can be executed periodically within the communication device to adjust the operation of the Bluetooth mode based on the prevailing signal conditions.

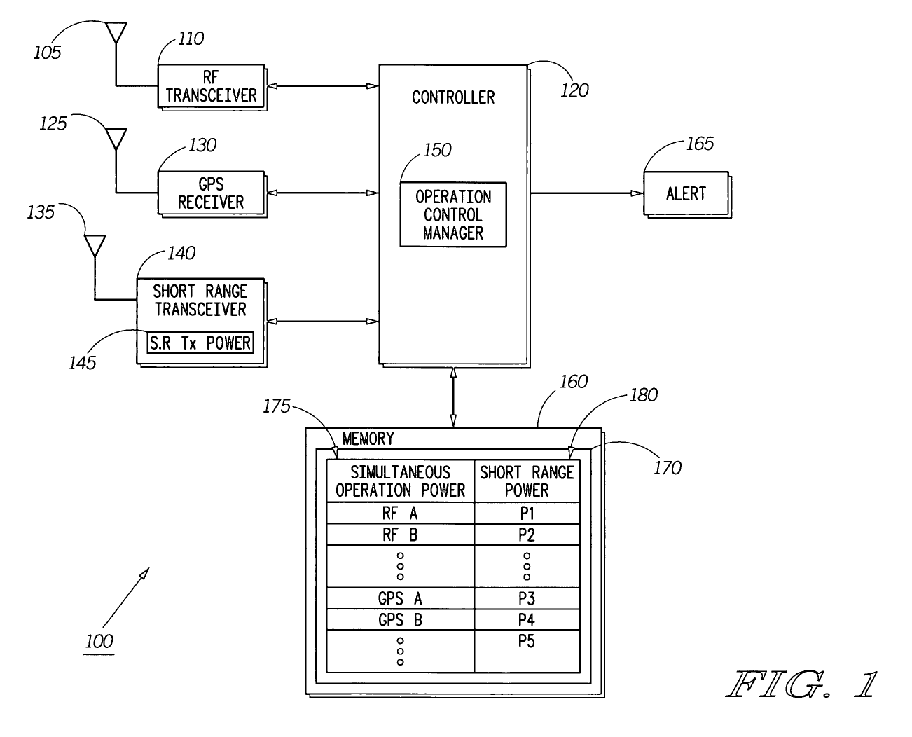

FIG. 1 is an electronic block diagram illustrating a communication device 100. The communication device 100, by way of example only, can be embodied in a cellular radiotelephone having a conventional cellular radio transceiver circuitry, as is known in the art, and will not be presented here for simplicity. The invention is alternatively applied to other communication devices such as, for example, messaging devices, personal digital assistants and personal computers with communication capability, mobile radio handsets, cordless radiotelephone and the like.

The communication device 100 includes conventional device hardware (also not represented for simplicity) such as user interfaces, displays, and the like, that are integrated in a compact housing. Each particular communication device will offer opportunities for implementing the present invention.

As illustrated in FIG. 1, the communication device 100 includes a radio frequency (RF) antenna 105, a RF transceiver 110, a GPS antenna 125, a GPS receiver 130, a short range antenna 135, a short range transceiver 140, a controller 120, a memory 160, and an alert module 165.

The RF antenna 105 intercepts transmitted signals from one or more radio frequency networks and transmits signals to the one or more radio frequency networks. For example, the RF antenna 105 and RF transceiver 110 can operate at 1.9 GHz (gigahertz) on a PCS (Personal Communication Services) Band. The RF antenna 105 is coupled to the RF transceiver 110, which employs conventional demodulation techniques for receiving the radio frequency communication signals. The RF transceiver 110 is coupled to the controller 120 and is responsive to commands from the controller 120. When the RF transceiver 110 receives a command from the controller 120, the RF transceiver 110 sends a signal via the RF antenna 105 to one or more of the RF communication systems. In this manner, the RF antenna 105 and the RF transceiver 110 are utilized by the communication device 100 to operate in a radio frequency operating mode.

In an alternative embodiment (not shown), the communication device 100 includes a receive antenna and a receiver for receiving signals from one or more of the RF communication systems and a transmit antenna and a transmitter for transmitting signals to one or more of the RF communication systems. It will be appreciated by one of ordinary skill in the art that other similar electronic block diagrams of the same or alternate type can be utilized for the communication device 100.

It will be appreciated by one of ordinary skill in the art that the RF antenna 105 and RF transceiver 110 are adapted to communicate within various RF communication systems in accordance with at least one of several standards. These standards include analog, digital or dual-mode communication system protocols such as, but not limited to, the Advanced Mobile Phone System (AMPS), the Narrowband Advanced Mobile Phone System (NAMPS), the Global System for Mobile Communications (GSM), the IS-136 Time Division Multiple Access (TDMA) digital cellular system, the IS-95 Code Division Multiple Access (CDMA) digital cellular system, the CDMA 2000 system, the Wideband CDMA (W-CDMA) system, the Personal Communications System (PCS), the Third Generation (3G) system, the Universal Mobile Telecommunications System (UMTS) and variations and evolutions of these protocols. In the following description, the term “RF communication system” refers to any of the systems mentioned above or an equivalent. Additionally, it is envisioned that RF communication systems can include wireless local area networks, including pico-networks, or the like.

Coupled to the RF transceiver 110, is the controller 120 utilizing conventional signal-processing techniques for processing received messages. It will be appreciated by one of ordinary skill in the art that additional controllers can be utilized as required to handle the processing requirements of the controller 120. The controller 120 decodes an identification in the demodulated data of a received message and/or voice communication, compares the decoded identification with one or more identifications stored in the memory 160, and when a match is detected, proceeds to process the remaining portion of the received message and/or voice communication. The one or more identifications, for example, can be a unique selective call address assigned within a wireless communication system, an electronic mail address, an IP (internet protocol) address or any other similar identification.

The communication device 100 further includes the GPS antenna 125 coupled to the GPS receiver 130. The Global Positioning System (GPS) is a worldwide radio-navigation system formed from a constellation of 24 satellites and their ground stations. GPS receivers use these satellites as reference points to calculate positions accurate to a matter of meters. The GPS receiver 130 via the GPS antenna 125 receives signals broadcasted from a GPS system. The GPS receiver 130 is coupled to the controller 120, which processes the received GPS signals, in a manner well known in the art, to calculate the location of the communication device 100. In this manner, the GPS antenna 125 and the GPS receiver 130 are utilized by the communication device 100 to operate in a location tracking operating mode.

The GPS receiver 130 is coupled to the controller 120. The controller 120, in response to receiving a command that includes location information from the GPS receiver 130, stores the current location, preferably in the form of a latitude and longitude, in the memory 160.

The short range antenna 135 intercepts transmitted signals from one or more short range networks and transmits signals to the one or more radio short range networks. For example, the short range antenna 135 and the short range transceiver 140 can operate at 2.4 GHz (Gigahertz) on a Bluetooth Band. The short range antenna 135 is coupled to the short range transceiver 140, which employs conventional demodulation techniques for receiving the short range communication signals. The short range transceiver 140 is coupled to the controller 120 and is responsive to commands from the controller 120. When the RF transceiver 110 receives a command from the controller 120, the short range transceiver 140 sends a signal via the short range antenna 135 to one or more of the short range communication systems. In this manner, the short range antenna 135 and the short range transceiver 140 are utilized by the communication device 100 to operate in a short range operating mode.

The short range transceiver 140 operates using a short range transmit power 145 for communication purposes. The short range transmit power 145 preferably can be varied in accordance with signaling conditions and/or communication requirements.

In an alternative embodiment (not shown), the communication device 100 includes a short range receive antenna and a receiver for receiving signals from one or more of the short range communication systems and a short range transmit antenna and a transmitter for transmitting signals to one or more of the short range communication systems. It will be appreciated by one of ordinary skill in the art that other similar electronic block diagrams of the same or alternate type can be utilized for the communication device 100.

The controller 120, as illustrated, is coupled to the alert 165. Upon receipt and processing of a message or a call, the controller 120 preferably generates a command signal to the alert 165 as a notification that the message has been received and stored or alternatively that a call is waiting for a response. The alert 165 similarly can be utilized for other alerting notifications such as an alarm clock, a calendar event alert, an alert notification that a communication call has been disconnected or has failed, and the like. The alert 165 can include a speaker (not shown) with associated speaker drive circuitry capable of playing melodies and other audible alerts, a vibrator (not shown) with associated vibrator drive circuitry capable of producing a physical vibration, or one or more light emitting diodes (LEDs) (not shown) with associated LED drive circuitry capable of producing a visual alert. It will be appreciated by one of ordinary skill in the art that other similar alerting means as well as any combination of the audible, vibratory, and visual alert outputs herein described can be used for the alert 165.

To perform the necessary functions of the communication device 100, the controller 120 is operatively coupled to the memory 160, which can include a random access memory (RAM), a read-only memory (ROM), an electrically erasable programmable read-only memory (EEPROM), and flash memory. The memory 160, for example, includes memory locations for the storage of one or more received or transmitted messages, one or more software applications, one or more location data, and the like. It will be appreciated by those of ordinary skill in the art that the memory 160 can be integrated within the communication device 100, or alternatively, can be at least partially contained within an external memory such as a memory storage device. The memory storage device, for example, can be a subscriber identification module (SIM) card. A SIM card is an electronic device typically including a microprocessor unit and a memory suitable for encapsulating within a small flexible plastic card. The SIM card additionally includes some form of interface for communicating with the communication device 100. The SIM card can be used to transfer a variety of information from/to the communication device 100 and/or any other compatible device.

The memory 160, in accordance with one embodiment of the present invention, includes a short range transmit power look-up table 170. The short range transmit power look-up table 170 stores various simultaneous operation mode power levels 175 and associated predetermined short range transmit power levels 180. The simultaneous operation modes can be, for example, an RF communication mode, and/or a GPS communication mode, and the like.

The controller 120 preferably includes an operation control manager 150. Alternatively, the operation control manager 150 can be coupled to the controller 120 as a separate module. The operation control manager 150 can be hard coded or programmed into the communication device 100 during manufacturing, can be programmed over-the-air upon customer subscription, or can be a downloadable application. It will be appreciated that other programming methods can be utilized for programming the operation control manager 150 into the communication device 100. It will be further appreciated by one of ordinary skill in the art that the operation control manager 150 can be hardware circuitry within the communication device 100. The operation control manager 150 determines various parameters to be utilized by the various operation modes based on the current performance parameters of the various active operation modes.

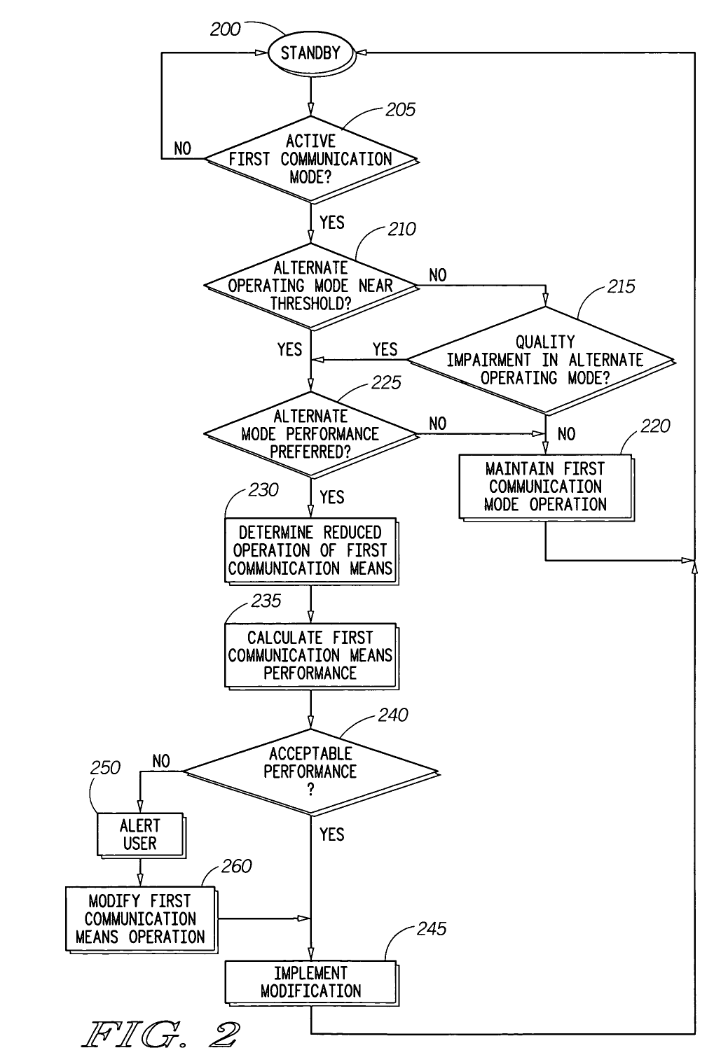

FIG. 2 is a flowchart illustrating one embodiment of the operation of the communication device of FIG. 1. Specifically, FIG. 2 illustrates one embodiment of the operation of the operation control manager 150. As illustrated, the operation begins with Step 200 in which the communication device 100 in standby mode. Standby mode runs the communication device 100 with minimal power to conserve battery life. Next, in Step 205, the operation control manager 150 determines whether a first communication mode is active. For example, the operation control manager 150 can determine whether a short range communication mode (such as a Bluetooth operating mode) is active. When no first communication mode is active, the operation cycles back to standby mode, Step 200, and then periodically checks for an active first communication mode, Step 205. When the communication device 100 is operating with a first communication mode, such as an active short range operating mode in Step 205, the process continues to Step 210 in which the operation control manager 150 checks all alternative active operating modes for threshold signal levels. For example, in Step 210, the operation control manager 150 determines whether the radio frequency communication operating mode and/or the GPS operating mode are operating near sensitivity, i.e. some loss of performance is expected. When no alternate active operating modes are near threshold in Step 210, the process continues to Step 215 in which the operation control manager 150 determines whether any other quality impairment exists within an alternate active operating mode. For example, the operation control manager 150 can compare the radio communication mode performance and/or the GPS performance to one or more predetermined quality metrics. When no quality impairment is detected in Step 215, the process continues to Step 220 in which the operation of the first communication mode is maintained. For example, when the first communication mode is a short range communication mode, the short range transmit power is maintained at a maximum preset level. The process then cycles back to the standby-mode of Step 200.

When one or more alternate active operating modes are near threshold performance in Step 210 or when a quality impairment is detected in one or more alternate active operating modes in Step 215, the process continues to Step 225 in which the operation control manager 150 determines whether the affected alternate active operating mode performance is preferred over the first communication mode operating performance. When the affected alternate active operating mode performance is not preferred, the reduced performance of the affected alternate active operating mode is accepted and the process continues to Step 220 in which the first communication mode operation is maintained. For example, when the first communication mode is a short range communication operating mode, the short range transmit power is maintained at a maximum preset level.

When the affected alternate operating mode performance is preferred in Step 225, the process continues to Step 230 in which the operation control manager 150 determines a reduced operation of the first communication means. For example, when the first communication means is a short range communication means, the operation control manager can determine a reduced short range transmit power. It will be appreciated that the operation control manager 150 can be programmed with an algorithm which calculates the desired reduction in signal level of the short range communication means based on the active alternate operating mode signal level. The calculation can be based on a formula or alternatively can be placed into a lookup table. For example, the operation control manager 150 can determine the associated short range transmit power by accessing the short range transmit power look-up table 170 in the memory 160. Next, in Step 235, the operation control manager 150 calculates the associated short range performance (i.e. such as sensitivity) using the new short range transmit power. Next, in Step 240, the operation control manager 150 determines whether the new first communication means' performance is acceptable. For example, the calculated short range performance can be compared to a preprogrammed sensitivity target for the short range operating mode. This preprogrammed target can vary based on the type of operating mode, e.g. voice or data. For example, when the short range communication mode is using Bluetooth, this comparison can indicate whether there is sufficient link margin in the Bluetooth link to allow reduction in the Bluetooth transmit power.

When the calculated first communication means' performance is not acceptable (for example, the short range transmit power is not acceptable), the process continues to Step 250 in which the user is alerted that some loss in performance may occur. For example, the operation control manager 150 can send a signal to the alert 165 to notify the user before the short range transmit power is reduced. The process then can optionally continue to Step 260 in which the user can modify the first communication means' operation mode. For example, the user can reduce the range of the Bluetooth link.

When the short range performance is acceptable in Step 240 and after the user modifies the first communication means' operation mode in Step 260, the process continues to Step 245 in which the modification is implemented. For example, the transmit power of the short range communication means can be reduced. By reducing the short range transmit power the noise injected into the alternate operating mode blocks is minimized. The process then cycles back to the standby mode Step 200.

The method as described herein allows the communication device to make adjustments to a first operating mode in order to maintain desired performance of one or more alternate operating modes. The method, for example, allows the communication device to make adjustments to the Bluetooth operating conditions, specifically transmit power, to reduce the loss of performance in the other operating modes such as cellular communication modes or GPS location modes. The use of reduced short range transmit power is able to reduce the deleterious effects of far out flat noise spectra. Additionally, the method described herein makes power control decisions to improve the performance of the communication device operating with multiple modes simultaneously.

While this disclosure includes what are considered presently to be the preferred embodiments and best modes of the invention described in a manner that establishes possession thereof by the inventors and that enables those of ordinary skill in the art to make and use the invention, it will be understood and appreciated that there are many equivalents to the preferred embodiments disclosed herein and that modifications and variations may be made without departing from the scope and spirit of the invention, which are to be limited not by the preferred embodiments but by the appended claims, including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of such software, if any, will be limited in the interest of brevity and minimization of any risk of obscuring the principles and concepts according to the present invention.

We claim:

1. A method of operation of a communication device comprising the steps of:
activating a first operating mode;
activating at least one alternate operating mode;
detecting a performance impact in the at least one alternate operating mode from the first operating mode; and
modifying the first mode.

2. The method of operation as recited in claim 1 further comprising prior to the detecting step, the step of:
detecting a quality impairment in the at least one alternate operating mode.

3. The method of operation as recited in claim 2 wherein the quality impairment comprises the at least one alternate mode having a signal level near a threshold level.

4. The method of operation as recited in claim 1 further comprising prior to the modifying step, the step of:
setting the at least one alternate operating mode as a preferred operating mode.

5. The method of operation as recited in claim 1 wherein the first operating mode comprises a short range communication mode, and wherein the modifying step comprises modifying a transmit power of the short range communication mode.

6. The method of operation as recited in claim 1 further comprising prior to the modifying step, the steps of:
identifying a first operating mode modification;
determining a first operating mode performance using the identified first operating mode modification; and
accepting the determined first operating mode performance,
wherein the modifying step comprises modifying the first operating mode using the first operating mode modification.

7. The method of operation as recited in claim 1 further comprising prior to the modifying step, the steps of:
identifying a first operating mode modification;
determining a first operating mode performance using the identified first operating mode modification;
alerting a user of the determined first operating mode performance; and
receiving a user input including an alternative first operating mode modification,
wherein the modifying step comprises modifying the first operating mode using the alternative first operating mode modification.

8. A communication device comprising:
a first communication means for operating in a first operating mode;
a second communication means for operating in a second operating mode; and
an operation control manager coupled between the first communication means and the second communication means, wherein the operation control manager is adapted to:
detect a performance impact in the second communication means; and
modify the first communication means to reduce the performance impact.

9. The communication device as recited in claim 8 wherein the first communication means is a short range transceiver.

10. The communication device as recited in claim 8 wherein the second communication means is selected from a group consisting of a radio frequency transceiver and a global positioning system receiver.

11. The communication device as recited in claim 8 wherein the performance impact comprises a quality impairment.

12. The communication device as recited in claim 11 wherein the quality impairment comprises a signal level near a threshold level.

13. The communication device as recited in claim 8, wherein the first communication means operates using a transmit power, and further wherein the operation control manager is adapted to modify the transmit power to reduce the performance impact.
